(19) United States
(12) Patent Application Publication
(10) Pub. No.: US 2026/0244212 A1
(43) Pub. Date: Aug. 20, 2026

(54) SYSTEM FOR CONTROLLING WORK MACHINE

(71) Applicant: KOMATSU LTD., Tokyo (JP)

(72) Inventors: Junji HARADA, Tokyo (JP); Eiji ISHIBASHI, Tokyo (JP); Daiki ARIMATSU, Tokyo (JP); Ryohei HASEGAWA, Tokyo (JP); Jungo MORIYASU, Tokyo (JP); Yosuke KOGAWA, Tokyo (JP); Tomoyuki IWASAWA, Tokyo (JP); Junki YAMAMOTO, Tokyo (JP); Ken NISHIHARA, Tokyo (JP)

(21) Appl. No.: 19/162,458

(22) PCT Filed: Apr. 11, 2024
(86) PCT No.: PCT/JP2024/014704

§ 371 Date: Sep. 5, 2025

(30) Foreign Application Priority Data
Jun. 28, 2023 (JP) 2023-105823

(51) Int. Cl. G05D 1/646; E02F 9/20; G05D 1/24; G05D 105/05

(52) U.S. Cl. CPC G05D 1/646; E02F 9/2045; G05D 1/24; G05D 2105/05

(57) ABSTRACT

A system controls a work machine. The system includes a traveling operation device, a sensor, and a controller. The traveling operation device outputs a traveling command for causing the work machine to travel. The sensor detects a position of the work machine. The controller controls a traveling direction of the work machine. The controller sets a target position. The controller acquires the position of the work machine. The controller sets, as a start position, the position of the work machine when receiving the traveling command for causing the work machine to travel. The controller determines a route passing through the start position and the target position as a target route. The controller controls the traveling direction of the work machine such that the work machine travels according to the target route.

### CROSS-REFERENCE TO RELATED APPLICATIONS

This application is a U.S. National stage application of International Application No. PCT/JP2024/014704, filed on Apr. 11, 2024. This U.S. National stage application claims priority under 35 U.S.C. § 119(a) to Japanese Patent Application No. 2023-105823, filed in Japan on Jun. 28, 2023. The entire contents of Japanese Patent Application No. 2023-105823 is hereby incorporated herein by reference.

### BACKGROUND

### Technical Field

The present disclosure relates to a system for controlling a work machine.

### Background Art

According to the related art, a technique for automatically controlling a work machine to travel according to a predetermined target route is known. For example, in a control system of a work machine of Japanese Laid-Open Patent Publication No. 2020-166303 A, a plurality of slots (target routes) extending in parallel to each other are set. Each of the plurality of slots includes a start position and an end position. The control system controls the work machine such that the work machine travels according to each of the plurality of slots.

For example, the work machine performs excavation with a work implement while traveling from a first start position to a first end position in accordance with a first slot. Next, the work machine moves to a second start position of a second slot, and performs excavation with the work implement while traveling from the second start position to a second end position according to the second slot. As the above work is repeated, the ground is excavated along each slot.

### SUMMARY

The work performed by work machines includes collecting materials such as earth and sand in one place. For example, at a site where ground leveling work is performed, earth excavated by the ground leveling work is loaded onto a dump truck by a hydraulic excavator. In this case, in order to efficiently perform the loading work by the hydraulic excavator, it is desirable to collect excavated earth and sand from around the hydraulic excavator to a predetermined area near the hydraulic excavator. An object of the present disclosure is to easily collect materials such as earth and sand from around a predetermined area to the predetermined area by a work machine.

A system according to a first aspect of the present disclosure is a system for controlling a work machine, and includes a traveling operation device, a sensor, and a controller. The traveling operation device outputs a traveling command for causing the work machine to travel. The sensor detects a position of the work machine. The controller controls a traveling direction of the work machine. The controller sets a target position. The controller acquires the position of the work machine. The controller sets, as a start position, the position of the work machine when receiving the traveling command for causing the work machine to travel. The controller determines a route passing through the start position and the target position as a target route. The controller controls the traveling direction of the work machine such that the work machine travels according to the target route.

In the system according to the first aspect, as the traveling command is outputted after the work machine is moved to a freely selected position, the freely selected position is set as the start position of the target route. Therefore, the traveling direction of the work machine is automatically controlled such that the work machine travels according to the target route from an freely selected start position toward the target position. Thus, materials can be easily collected from the freely selected start position around the target position to the target position.

A system according to a second aspect of the present disclosure is a system for controlling a work machine, and includes a sensor and a controller. The sensor detects a position of the work machine. The controller controls a traveling direction of the work machine. The controller sets a target position. The controller acquires the position of the work machine. The controller determines a plurality of target routes including a first target route and a second target route. The first target route passes through the target position. The second target route passes through the target position and extends to a different orientation from that of the first target route. The controller controls the traveling direction of the work machine such that the work machine travels according to each of the plurality of target routes.

In the system according to the second aspect, a plurality of target routes extending from different orientations toward the target position are set. Therefore, the traveling direction of the work machine is automatically controlled such that the work machine travels according to the target routes from the different orientations toward the target position. Thus, materials can be easily collected from around the target position to the target position.

A system according to a third aspect of the present disclosure is a system for controlling a work machine, and includes a traveling operation device, a sensor, and a controller. The traveling operation device outputs a traveling command for causing the work machine to travel. The sensor detects a position of the work machine. The controller controls a traveling direction of the work machine. The controller sets a target position. The controller acquires the position of the work machine. Upon receiving the traveling command for causing the work machine to travel, the controller controls the traveling direction of the work machine such that the work machine moves toward the target position. The controller maintains the setting of the target position even when the traveling command is canceled.

In the system according to the third aspect, as the traveling command is outputted after the work machine is moved to a freely selected position, the traveling direction of the work machine is automatically controlled from the freely selected position toward the target position. Thus, materials can be easily collected from a freely selected position around the target position to the target position.

According to the present disclosure, materials such as earth and sand can be easily collected from around a predetermined area to the predetermined area by the work machine.

### BRIEF DESCRIPTION OF DRAWINGS

Referring now to the attached drawings which form a part of this original disclosure, an illustrative embodiment is shown.

FIG. 1 is a side view showing a work machine according to an embodiment.

FIG. 2 is a block diagram showing the configuration of a drive system and a control system of the work machine.

FIG. 3 is a diagram showing an example of work executed by the work machine.

FIG. 4 is a flowchart showing processing of automatic control of the work machine according to a first embodiment.

FIG. 5 is a diagram showing the operation of the work machine in the automatic control according to the first embodiment.

FIG. 6 is a diagram showing the operation of the work machine in the automatic control according to the first embodiment.

FIG. 7 is a diagram showing the operation of the work machine in the automatic control according to the first embodiment.

FIG. 8 is a diagram showing the operation of the work machine in the automatic control according to the first embodiment.

FIG. 9 is a diagram showing the operation of the work machine in the automatic control according to the first embodiment.

FIG. 10 is a diagram showing the operation of the work machine in the automatic control according to the first embodiment.

FIG. 11 is a diagram showing the operation of the work machine in the automatic control according to the first embodiment.

FIG. 12 is a flowchart showing processing of automatic control of the work machine according to a second embodiment.

FIG. 13 is a diagram showing the operation of the work machine in the automatic control according to the second embodiment.

FIG. 14 is a diagram showing the operation of the work machine in the automatic control according to the second embodiment.

FIG. 15 is a diagram showing the operation of the work machine in the automatic control according to the second embodiment.

FIG. 16 is a flowchart showing processing of automatic control of the work machine according to a third embodiment.

FIG. 17 is a diagram showing the operation of the work machine in the automatic control according to the third embodiment.

FIG. 18 is a diagram showing the operation of the work machine in the automatic control according to the third embodiment.

### DETAILED DESCRIPTION OF EMBODIMENTS

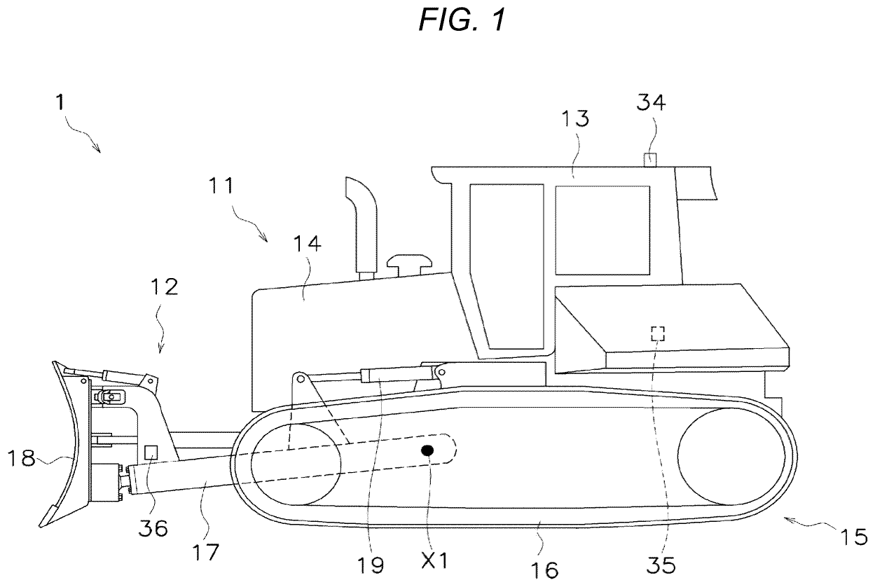

Hereinafter, a work machine according to an embodiment will be described with reference to the drawings. FIG. 1 is a side view illustrating a work machine 1 according to the embodiment. The work machine 1 according to the present embodiment is a bulldozer. The work machine 1 includes a vehicle body 11 and a work implement 12.

The vehicle body 11 includes a cab 13, an engine compartment 14, and a traveling device 15. An operator's seat, not illustrated, is disposed in the cab 13. The engine compartment 14 is disposed in front of the cab 13. The traveling device 15 is provided at a lower part of the vehicle body 11. The traveling device 15 includes a pair of left and right crawler tracks 16. In FIG. 1, only the left crawler track 16 is shown. The work machine 1 travels as the crawler tracks 16 turn around.

The work implement 12 is attached to the vehicle body 11. The work implement 12 includes a lift frame 17, a blade 18, and a lift actuator 19. The lift frame 17 is supported to be rotationally movable about a lift shaft X1 in relation to the vehicle body 11. The blade 18 is arranged in front of the vehicle body 11. The blade 18 is supported by the lift frame 17. The lift actuator 19 is coupled to the vehicle body 11 and the lift frame 17. Alternatively, the lift actuator 19 may be coupled to the vehicle body 11 and the blade 18. The lift actuator 19 is a hydraulic cylinder. When the lift actuator 19 expands and contracts, the lift frame 17 moves up and down. The blade 18 moves up and down as the lift frame 17 moves up and down.

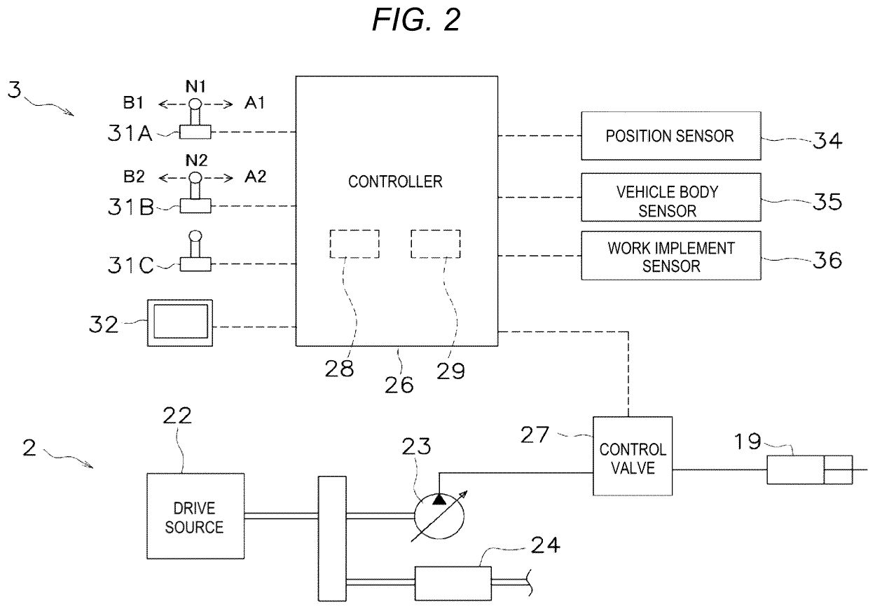

FIG. 2 is a block diagram illustrating the configuration of a drive system 2 and a control system 3 of the work machine 1. As shown in FIG. 2, the drive system 2 includes a drive source 22, a hydraulic pump 23, and a power transmission device 24. The drive source 22 includes, for example, an internal combustion engine. The drive source 22 may include an electric motor. The hydraulic pump 23 is driven by the drive source 22 and discharges hydraulic oil. The hydraulic oil discharged from the hydraulic pump 23 is supplied to the lift actuator 19. Although one hydraulic pump 23 is illustrated in FIG. 2, a plurality of hydraulic pumps may be provided.

The power transmission device 24 transmits the driving force of the drive source 22 to the traveling device 15. The power transmission device 24 may be, for example, a hydrostatic transmission (HST). Alternatively, the power transmission device 24 may be, for example, a torque converter or a transmission having a plurality of transmission gears.

The control system 3 includes a controller 26 and a control valve 27. The controller 26 is programmed to control the work machine 1, based on acquired data. The controller 26 includes a storage device 28 and a processor 29. The processor 29 includes, for example, a CPU. The storage device 28 includes, for example, a memory and an auxiliary storage device. The storage device 28 may be, for example, a RAM or a ROM. The storage device 28 may be a semiconductor memory, a hard disk, or the like. The storage device 28 stores computer commands that are executable by the processor 29 and configured to control the work machine 1.

The control valve 27 is a proportional control valve and is controlled by a command signal from the controller 26. The control valve 27 is disposed between a hydraulic actuator such as the lift actuator 19 and the hydraulic pump 23. The control valve 27 controls the flow rate of the hydraulic oil supplied from the hydraulic pump 23 to the lift actuator 19. The control valve 27 may be a pressure proportional control valve. Alternatively, the control valve 27 may be an electromagnetic proportional control valve.

The control system 3 includes a traveling operation device 31A, a steering operation device 31B, and a work implement operation device 31C. The traveling operation device 31A can be operated by an operator to manually operate the work machine 1 to travel forward and backward. The traveling operation device 31A includes, for example, a traveling lever. However, the traveling operation device 31A may include another member such as a switch. The traveling operation device 31A is operable to a forward position A1 and a backward position B1 from a neutral position N1. The traveling operation device 31A outputs a traveling command corresponding to the operation of the operator to the controller 26.

The steering operation device 31B can be operated by the operator to manually steer the work machine 1. The steering operation device 31B includes, for example, a steering lever. However, the steering operation device 31B may include another member such as a steering wheel or a switch. The steering operation device 31B is operable in a right turning direction A2 and a left turning direction B2 from a neutral position N2. The steering operation device 31B outputs a steering command corresponding to the operation of the operator to the controller 26.

The work implement operation device 31C can be operated by the operator to manually operate the work implement 12. The work implement operation device 31C includes, for example, a work implement lever. However, the work implement operation device 31C may include another member such as a switch. The work implement operation device 31C outputs a work command corresponding to the operation of the operator to the controller 26. Each of the operation devices 31A to 33C may be configured with a common member.

The controller 26 controls the drive source 22 and the power transmission device 24 so as to cause the work machine 1 to travel in response to a traveling command from the traveling operation device 31A. Thus, the work machine 1 moves forward or backward according to the operation of the traveling operation device 31A by the operator.

The controller 26 controls the drive source 22 and the power transmission device 24 so as to steer the work machine 1 to the left and right in response to a steering command from the steering operation device 31B. For example, the controller 26 turns the work machine 1 to the left and right, based on the speed difference between the left and right crawler tracks 16. Thus, the work machine 1 turns leftward or rightward according to the operation of the steering operation device 31B by the operator.

The controller 26 controls the control valve 27 so as to cause the work implement 12 to operate in response to a work command from the work implement operation device 31C. Thus, the work implement 12 moves up and down according to the operation of the work implement operation device 31C by the operator.

The control system 3 includes an input device 32. The input device 32 includes, for example, a touch panel. However, the input device 32 may include another device such as a switch. The operator can set automatic control of the work machine 1, using the input device 32. The automatic control of the work machine 1 will be described in detail later.

The control system 3 includes a position sensor 34, a vehicle body sensor 35, and a work implement sensor 36. The position sensor 34 is attached to the vehicle body 11. The position sensor 34 includes, for example, a sensor based on a global navigation satellite system (GNSS). The position sensor 34 detects the position and orientation of the vehicle body 11. The position sensor 34 outputs a detection signal indicating the position and orientation of the vehicle body 11.

The vehicle body sensor 35 is attached to the vehicle body 11. The vehicle body sensor 35 detects the posture of the vehicle body 11. For example, the vehicle body sensor 35 detects the pitch angle and the roll angle of the vehicle body 11. The work implement sensor 36 is attached to the work implement 12. The work implement sensor 36 detects the posture of the work implement 12. For example, the work implement sensor 36 detects the pitch angle of the work implement 12.

Each of the vehicle body sensor 35 and the work implement sensor 36 is an inertial measurement unit (IMU). However, the work implement sensor 36 is not limited to the IMU, and may be another sensor such as an angle sensor or a cylinder stroke sensor. Each of the vehicle body sensor 35 and the work implement sensor 36 outputs a detection signal indicating the detected angle.

The controller 26 receives the detection signals from the position sensor 34, the vehicle body sensor 35, and the work implement sensor 36. The controller 26 calculates the position and orientation of the work machine 1, based on the detection signals. The controller 26 performs automatic control for controlling the traveling direction of the work machine, based on the position and orientation of the work machine 1. Hereinafter, the automatic control of the work machine will be described.

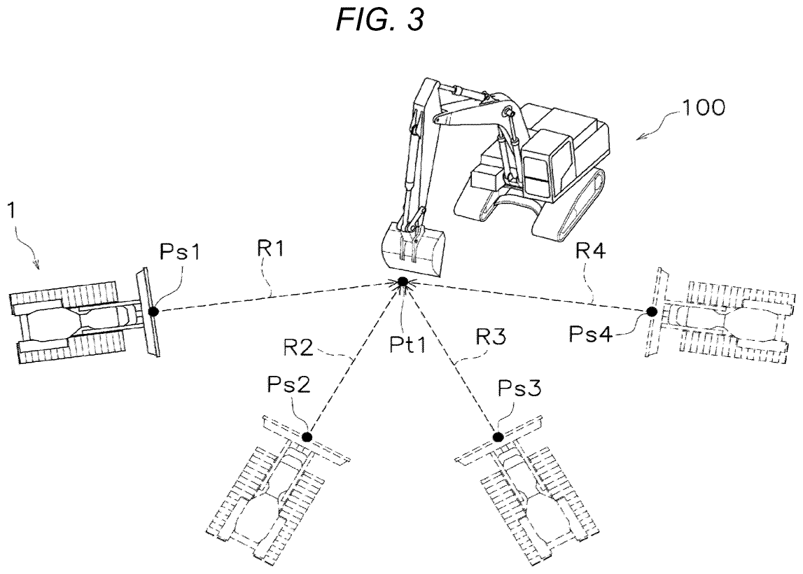

As illustrated in FIG. 3, the work machine 1 performs work of collecting materials such as earth and sand from around a predetermined target position Pt1 to the target position Pt1. The target position Pt1 is located, for example, near an excavator 100. The controller 26 automatically controls the traveling direction of the work machine 1 in this work and thus assists the operation of the work machine 1 by the operator.

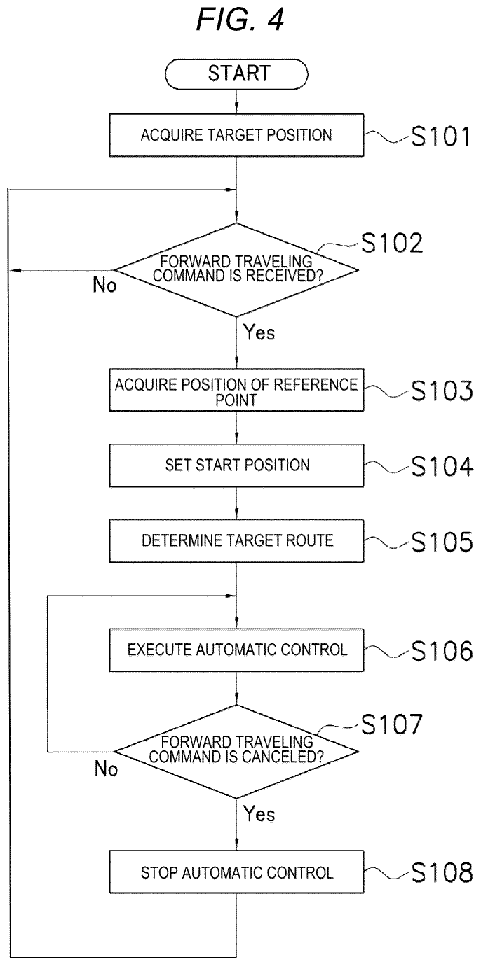

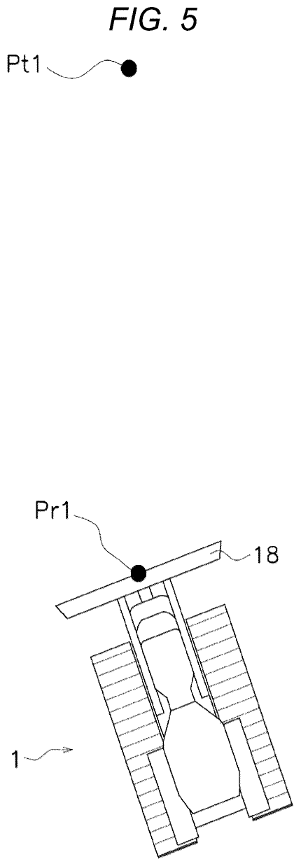

FIG. 4 is a flowchart showing the processing of automatic control of the work machine 1 according to a first embodiment. As shown in FIG. 4, in step S101, the controller 26 sets the target position Pt1. As illustrated in FIG. 5, the target position Pt1 is set at the work site where the work machine 1 is disposed. The target position Pt1 is set by the operator operating the input device 32. For example, a map of the work site is displayed on the input device 32, and the controller 26 sets a position on the map touched by the operator as the target position Pt1.

In step S102, the controller 26 determines whether a forward traveling command is received. When the traveling operation device 31A is operated to the forward position A1, the controller 26 determines that a forward traveling command is received. When the controller 26 receives the forward traveling command, the processing proceeds to step S103.

In step S103, the controller 26 acquires the position of a reference point Pr1. The reference point Pr1 is a predetermined part in the work machine 1. As shown in FIG. 5, the position of the reference point Pr1 is, for example, the center of the blade edge of the blade 18. The controller 26 calculates the position of the reference point Pr1, based on the detection signals received from the position sensor 34, the vehicle body sensor 35, and the work implement sensor 36.

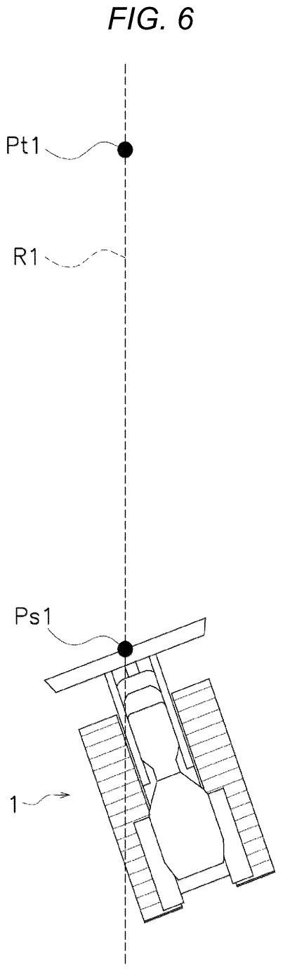

In step S104, the controller 26 sets a start position Ps1. The controller 26 sets the position of the reference point Pr1 when the forward traveling command is received, as the start position Ps1. In step S105, the controller 26 determines a target route R1. As shown in FIG. 6, the controller 26 determines a route passing through the start position Ps1 and the target position Pt1, as the target route R1.

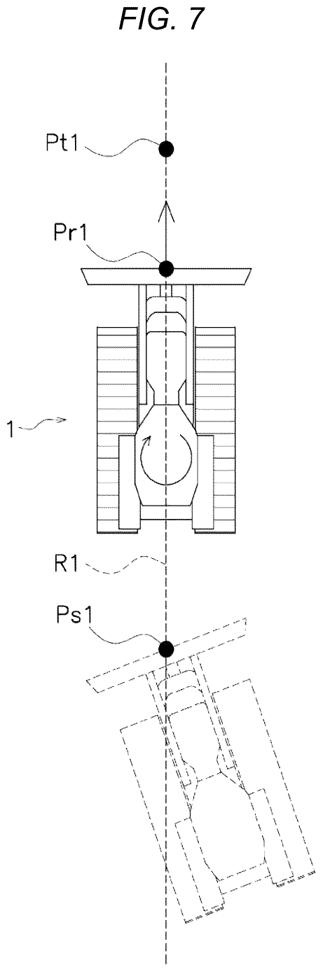

In step S106, the controller 26 executes the automatic control of the work machine 1. As illustrated in FIG. 7, the controller 26 causes the work machine 1 to travel forward in response to the forward traveling command and controls the traveling direction of the work machine 1 such that the work machine 1 travels according to the target route R1. That is, the controller 26 steers the work machine 1 such that the work machine 1 travels along the target route R1 toward the target position Pt1. Specifically, the controller 26 turns the work machine 1 such that the reference point Pr1 travels along the target route R1 toward the target position Pt1. Thus, the work machine 1 moves forward while turning toward the target position Pt1 simply by the operator operating the traveling operation device 31A without operating the steering operation device 31B.

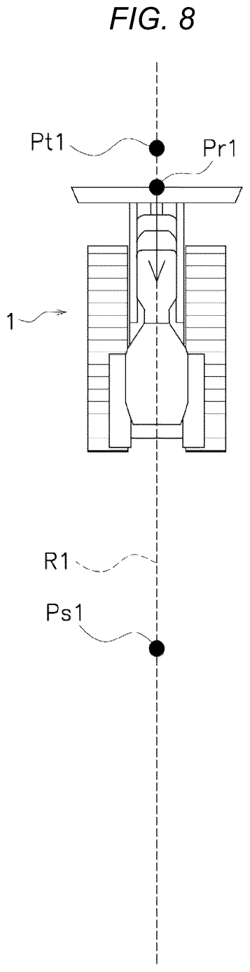

In step S107, the controller 26 determines whether the forward traveling command is canceled. When the traveling operation device 31A is operated to the neutral position N1 or the backward position B1, the controller 26 determines that the forward traveling command is canceled. For example, as shown in FIG. 8, after the work machine 1 reaches the target position Pt1, the operator switches the traveling operation device 31A from the forward position A1 to the backward position B1. Thus, the controller 26 causes the work machine 1 to travel backward and determines that the forward traveling command is canceled. When the forward traveling command is canceled, the processing proceeds to step S108.

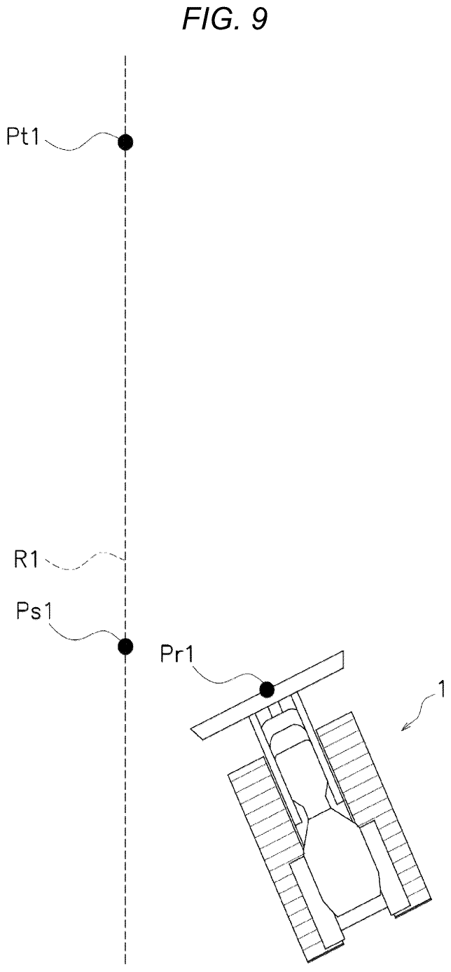

In step S108, the controller 26 stops the automatic control. Thus, the operator manually operates the traveling direction of the work machine 1. For example, as shown in FIG. 9, the operator manually operates the traveling operation device 31A and the steering operation device 31B to move the work machine 1 to a position deviating from the target route R1. Also, when the operator operates the steering operation device 31B during the execution of the automatic control, the controller 26 stops the automatic control.

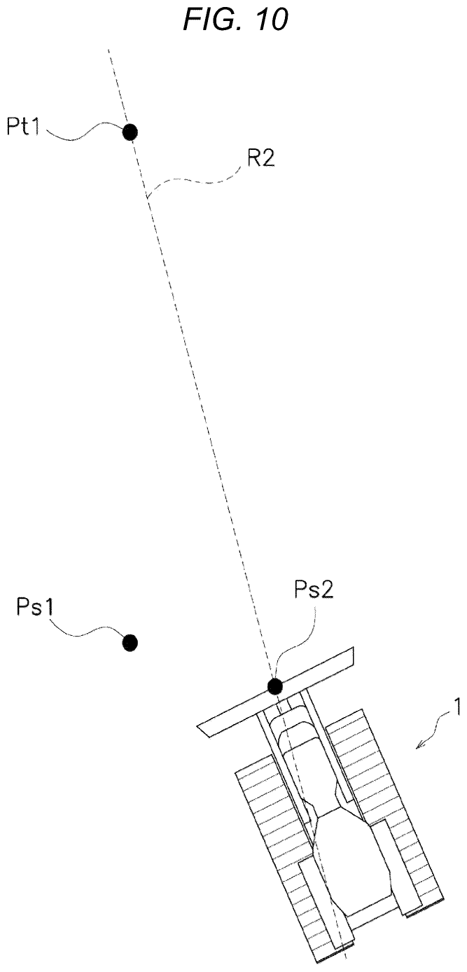

Subsequently, when the operator operates the traveling operation device 31A to the forward travel position A1 again, the controller 26 receives the next forward traveling command. Thus, as shown in FIG. 10, the controller 26 resets the position of the reference point Pr1 of the work machine 1 when the next forward traveling command is received, as a next start position Ps2. However, the controller 26 maintains the setting of the target position Pt1. Then, the controller 26 determines a route passing through the next start position Ps2 and the target position Pt1, as a next target route R2.

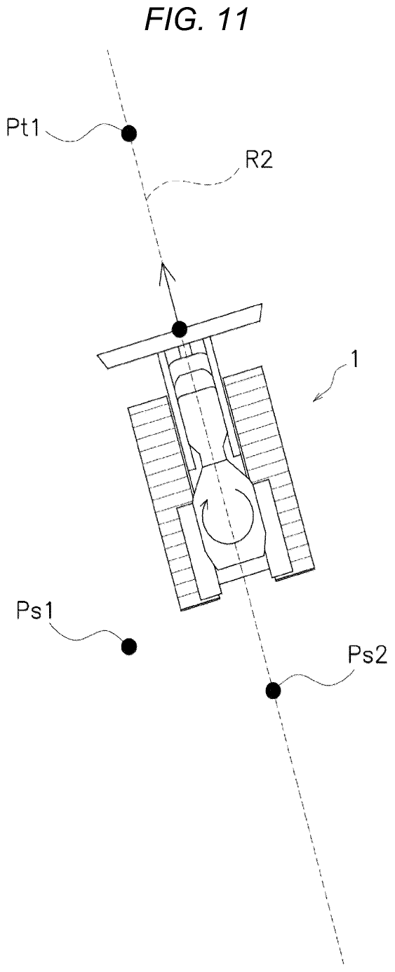

Then, as shown in FIG. 11, the controller 26 causes the work machine 1 to travel forward in response to the forward traveling command and controls the traveling direction of the work machine 1 by automatic control such that the work machine 1 travels according to the target route R2. As the above operation is repeated, the work machine 1 collects materials such as earth and sand from around the target position Pt1 to the target position Pt1.

In the automatic control of the work machine 1 according to the first embodiment described above, as a forward traveling command is outputted after the work machine 1 is moved to a freely selected position, the freely selected position is set as the start position of the target route. For example, as shown in FIG. 3, freely selected positions around the target position Pt1 are set as start positions Ps1 to Ps4. Then, target routes R1 to R4 from the freely selected start positions Ps1 to Ps4 toward the target position Pt1 are determined, and the traveling direction of the work machine 1 is automatically controlled such that the work machine 1 travels according to each of the target routes R1 to R4. Thus, materials can be easily collected from the freely selected start positions Ps1 to Ps4 around the target position Pt1 to the target position Pt1.

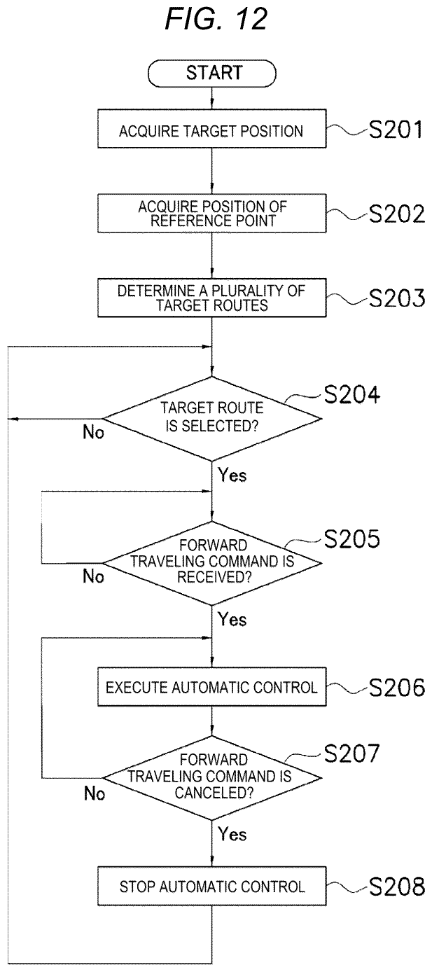

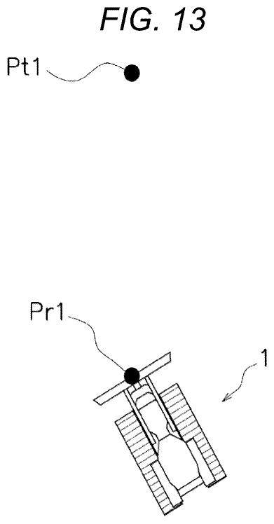

Next, automatic control of the work machine 1 according to a second embodiment will be described. FIG. 12 is a flowchart showing the processing of automatic control of the work machine 1 according to the second embodiment. As shown in FIG. 12, in step S201, the controller 26 sets the target position Pt1. In step S202, the controller 26 acquires the position of the reference point Pr1 of the work machine 1. As shown in FIG. 13, the target position Pt1 and the reference point Pr1 are similar to those in the above-described first embodiment.

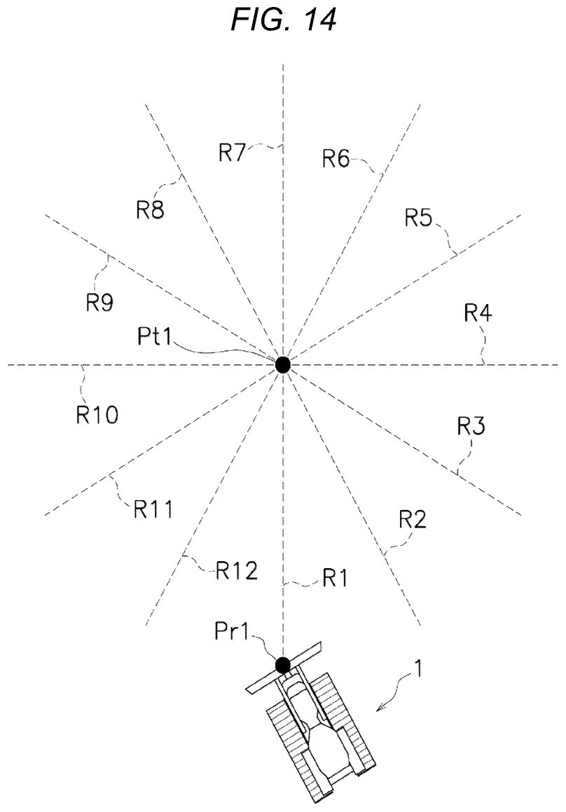

In step S203, the controller 26 determines a plurality of target routes R1 to R12. As shown in FIG. 14, the plurality of target routes R1 to R12 extend radially from the target position Pt1 as the center. The plurality of target routes R1 to R12 extend at equal angles from the target position Pt1 as a center.

For example, the controller 26 determines the first target route R1 passing through the reference point Pr1 and the target position Pt1. Also, the number of the plurality of target routes R1 to R12 is set, and the controller 26 calculates the target angle between the plurality of target routes R1 to R12, based on the number of the plurality of target routes R1 to R12. The controller 26 determines the other target routes R2 to 12 so as to be spaced apart by the target angle, starting from the first target route R1, with the target position Pt1 serving as the center.

For example, in the example shown in FIG. 14, the plurality of target routes R1 to R12 include first to twelfth target routes R1 to R12. The first to twelfth target routes R1 to R12 pass through the target position Pt1 and extend in different orientations. In the example shown in FIG. 14, the number of the plurality of target routes R1 to R12 is 12. However, the number of the plurality of target routes is not limited to 12 and may be less than 12 or more than 12.

In step S204, the controller 26 determines whether the target route R1 is selected. The operator selects one target route from the plurality of target routes R1 to R12, for example, by operating the input device 32. Here, it is assumed that the first target route R1 is selected.

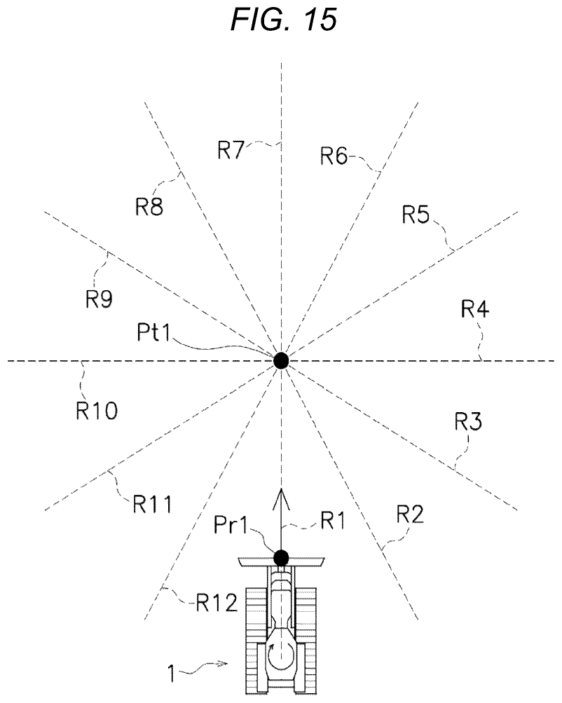

In step S205, the controller 26 determines whether a forward traveling command is received. When the controller 26 receives the forward traveling command, the controller 26 executes the automatic control in step S206. Thus, as illustrated in FIG. 15, the controller 26 causes the work machine 1 to travel forward and controls the traveling direction of the work machine 1 such that the work machine 1 travels according to the first target route R1 selected via the input device 32.

In step S207, as in the first embodiment, the controller 26 determines whether the forward traveling command is canceled. When the forward traveling command is canceled, the controller 26 stops the automatic control in step S208 as in the first embodiment.

Next, when the operator selects the next target route, the controller 26 in steps S204 to S206 causes the work machine 1 to travel forward and controls the traveling direction of the work machine 1 such that the work machine 1 travels according to the next target route selected via the input device 32. As the above operation is repeated, the work machine 1 collects materials such as earth and sand from around the target position Pt1 to the target position Pt1.

In the automatic control of the work machine 1 according to the second embodiment described above, the plurality of target routes R1 to R12 extending from different orientations toward the target position Pt1 are set. Therefore, the traveling direction of the work machine 1 is automatically controlled such that the work machine 1 travels according to the target route from different orientations toward the target position Pt1. Thus, materials can be easily collected from around the target position Pt1 to the target position Pt1.

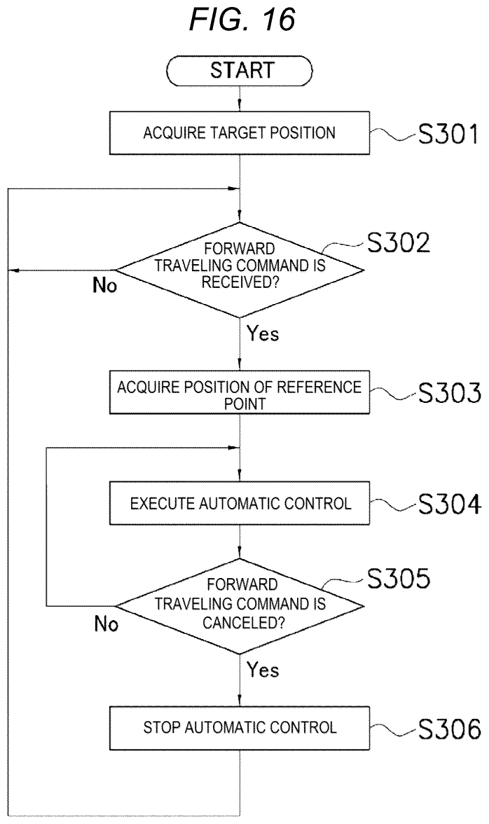

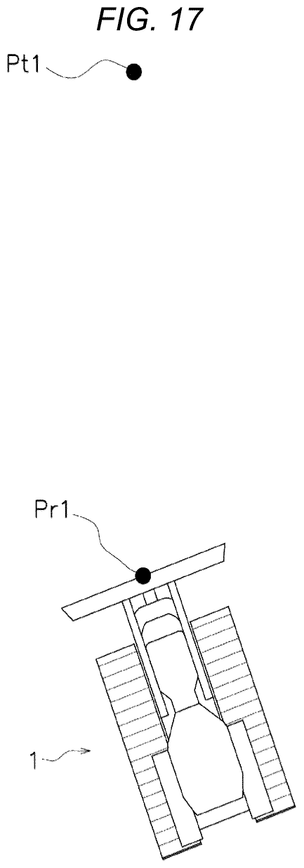

Next, automatic control of the work machine 1 according to a third embodiment will be described. FIG. 16 is a flowchart showing the processing of automatic control of the work machine 1 according to the third embodiment. As shown in FIG. 16, in step S301, the controller 26 sets the target position Pt1. In step S302, the controller 26 determines whether a forward traveling command is received. In step S303, the controller 26 acquires the position of the reference point Pr1. Steps S301 to S303 are similar to steps S101 to S103 in the first embodiment. As shown in FIG. 17, the target position Pt1 and the reference point Pr1 are similar to those in the above-described first embodiment.

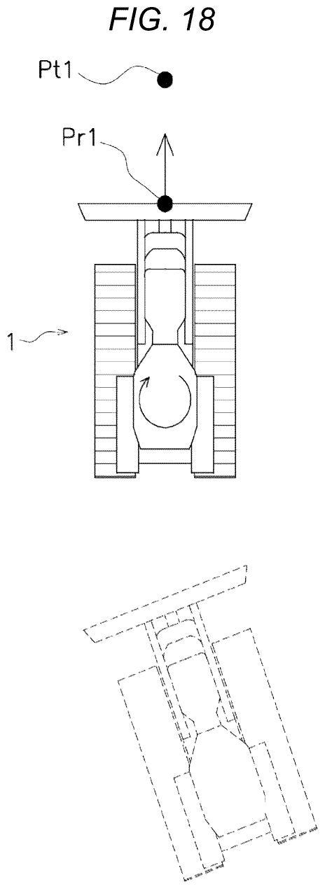

In step S304, the controller 26 executes the automatic control. The controller 26 controls the traveling direction of the work machine 1 such that the work machine 1 moves toward the target position Pt1. Specifically, as shown in FIG. 18, the controller 26 controls the traveling direction of the work machine 1 such that the reference point Pr1 of the work machine 1 moves toward the target position Pt1. In the automatic control according to the third embodiment, the controller 26 controls the traveling direction of the work machine 1 such that the work machine 1 moves toward the target position Pt1 without setting the target route R1.

In step S305, the controller 26 determines whether the forward traveling command is canceled. When the forward traveling command is canceled, the controller 26 stops the automatic control in step S306. Steps S305 and S306 are similar to steps S107 to S108 in the first embodiment.

For example, after the work machine 1 reaches the target position Pt1, the operator manually operates the traveling operation device 31A and the steering operation device 31B to move the work machine 1 to a position different from the position where the previous forward traveling command is received. At this time, the controller 26 maintains the setting of the target position Pt1 even when the traveling direction of the work machine 1 is changed according to the steering operation device 31B.

Subsequently, when the operator operates the traveling operation device 31A to the forward travel position A1 again, the controller 26 receives the next forward traveling command. Thus, the controller 26 controls the traveling direction of the work machine 1 such that the work machine 1 moves toward the target position Pt1 again from the position of the work machine 1 when receiving the next forward traveling command. As the above operation is repeated, the work machine 1 collects materials such as earth and sand from around the target position Pt1 to the target position Pt1.

In the automatic control of the work machine 1 according to the third embodiment described above, as a forward traveling command is outputted after the work machine 1 is moved to a freely selected position, the traveling direction of the work machine 1 is automatically controlled from the freely selected position toward the target position Pt1. Thus, materials can be easily collected from a freely selected position around the target position Pt1 to the target position Pt1.

Although several embodiments of the present disclosure have been described above, the present disclosure is not limited to the above-described embodiments, and various modifications can be made without departing from the spirit and scope of the invention.

The work machine 1 is not limited to a bulldozer and may be another vehicle such as a wheel loader or a motor grader. The work machine 1 may be remotely operable. In this case, the operation devices 31A-31C and the input device 32 may be disposed outside the work machine 1. The work machine 1 may include a plurality of controllers separate from each other. The processing by the controller 26 described above may be distributed to and executed by a plurality of controllers.

The processing of automatic control by the controller 26 is not limited to those of the above embodiments and may be changed. The method of setting the target position Pt1 is not limited to those of the above embodiments and may be changed. For example, the controller 26 may acquire the target position Pt1 from the excavator 100. The controller 26 may determine the target position Pt1 from the history of the previous work. For example, the controller 26 may determine, as a target position Ot1, the position of the work machine 1 when the traveling operation device 31A is switched from the forward position A1 to the backward position B1 in the previous work.

The reference point Pr1 is not limited to the center of the cutting edge of the blade 18 and may be another position. For example, the reference point Pr1 may be provided on the vehicle body 11. The reference point Pr1 may be the center of turning of the work machine 1.

In the second embodiment, the plurality of target routes R1 to R12 may not be arranged at equal intervals. The method of setting the first target route R1 is not limited to that of the second embodiment described above and may be changed. For example, the first target route R1 may be set by the operator operating the input device 32. In the second embodiment, the controller 26 may start the automatic control when the target route R1 is selected. Alternatively, the controller 26 may start the automatic control when the operator operates the input device 32 after selecting the target route R1.

According to the present disclosure, materials such as earth and sand can be easily collected from around a predetermined area to the predetermined area by the work machine.

1. A system for controlling a work machine, the system comprising:
a traveling operation device configured to output a traveling command in order to cause the work machine to travel;
a sensor configured to detect a position of the work machine; and
a controller configured to control a traveling direction of the work machine, the controller being configured to
set a target position,
acquire the position of the work machine,
set, as a start position, the position of the work machine when receiving the traveling command for causing the work machine to travel,
determine, as a target route, a route passing through the start position and the target position, and
control the traveling direction of the work machine such that the work machine travels according to the target route.

2. The system according to claim 1, wherein
the controller is configured to maintain the setting of the target position even when the traveling command is canceled.

3. The system according to claim 1, wherein
the controller is configured to
when receiving a next traveling command after the traveling command of a previous time is canceled, reset the position of the work machine when the receiving next traveling command, as a next start position, and
determine a route passing through the next start position and the target position as a next target route.

4. The system according to claim 3, wherein
the traveling operation device is manually operable from a neutral position to a forward position and a backward position, and
the controller is configured to
set, as the start position of the target route, the position of the work machine when receiving the traveling commands such that the traveling operation device is operated to the forward position, and
determine that the traveling command is canceled when the traveling operation device is operated to the neutral position or the backward position.

5. The system according to claim 1, further comprising:
a steering operation device operable to manually steer the work machine,
the controller being configured to
maintain the setting of the target position even when the work machine moves to a position deviating from the target route of a previous time according to the operation of the steering operation device after the traveling command of the previous time is canceled,
when receiving a next traveling command, reset the position of the work machine when receiving the next traveling command, as a next start position, and
determine a route passing through the next start position and the target position as a next target route.

6. A system for controlling a work machine, the system comprising:
a sensor configured to detect a position of the work machine; and
a controller configured to control a traveling direction of the work machine,
the controller being configured to
set a target position,
acquire the position of the work machine,
determine a plurality of target routes including a first target route passing through the target position and a second target route passing through the target position and extending in a different orientation from the orientation of the first target route, and
control the traveling direction of the work machine such that the work machine travels according to each of the plurality of target routes.

7. The system according to claim 6, wherein the controller is configured to determine the plurality of target routes so as to extend radially from the target position as a center.

8. The system according to claim 6, wherein the controller is configured to determine the plurality of target routes so as to extend at equal angles from the target position as a center.

9. The system according to claim 6, further comprising:
an input device operable by an operator, the controller being configured to control the traveling direction of the work machine such that the work machine travels according to a target route selected via the input device, among the plurality of target routes.

10. A system for controlling a work machine, the system comprising:
a traveling operation device configured to output a traveling command in order to cause the work machine to travel;
a sensor configured to detect a position of the work machine; and
a controller configured to control a traveling direction of the work machine, the controller being configured to
set a target position,
acquire the position of the work machine,
control the traveling direction of the work machine such that the work machine moves toward the target position when the traveling command for causing the work machine to travel is received, and
maintain the setting of the target position even when the traveling command is canceled.

11. The system according to claim 10, wherein
the controller is configured to control the traveling direction of the work machine such that the work machine moves toward the target position again when receiving a next traveling command after the traveling command of a previous time is canceled.

12. The system according to claim 11, wherein
the traveling operation device is manually operable from a neutral position to a forward position and a backward position, and
the controller is configured to
when receiving the traveling command as the traveling operation device is operated to the forward position, control the traveling direction of the work machine such that the work machine moves toward the target position, and
determine that the traveling command is canceled, when the traveling operation device is operated to the neutral position or the backward position.

13. The system according to claim 10, further comprising:
a steering operation device operable to manually steer the work machine, the controller being configured to
maintain the setting of the target position even when the traveling direction of the work machine is changed according to the steering operation device after the traveling command of a previous time is canceled, and
control the traveling direction of the work machine such that the work machine moves toward the target position again when a next traveling command is received.
